(19) United States
(12) Patent Application Publication
(10) Pub. No.: US 2003/0038838 A1
(43) Pub. Date: Feb. 27, 2003

(54) Method of displaying content

(75) Inventor: Mike Pollitt, Surry Hills (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Rumble Group Pty Limited, Surry Hills (AU)

(21) Appl. No.: 09/991,432

(22) Filed: Nov. 20, 2001

(30) Foreign Application Priority Data
Aug. 27, 2001 (AU) PR7284

(51) Int. Cl. G09G 5/00

(52) U.S. Cl. 345/741

(57) ABSTRACT

The present invention relates to a method and apparatus for displaying content and in particular, to digital rights management methods and apparatus.

In a first broad form the present invention provides a method of displaying content to a user, the content being formed from a sequence of data frames, each data frame being encoded using a predetermined algorithm, the sequence of data frames including at least one criteria frame indicating one or more criteria to be satisfied in order to allow at least some of the content to be displayed, the method including:

i) Determining if the next data frame is a criteria frame; and, ii) In response to a successful determination;

(1) Determining the one or more criteria;

(2) Comparing the one or more criteria to user data, the user data indicating whether the criteria are satisfied for the respective user;

(3) Decoding a number of the following data frames in response to a successful comparison; and,

(4) Displaying the content contained therein.

### BACKGROUND OF THE INVENTION

Digital Rights Management (DRM) refers to the ability to control access to digital media, such as audio and/or video information in such a manner as to prevent unauthorized duplication and/or distribution. This is particularly important as it allows digital media to be distributed in a controlled manner, such as on a pay per view basis.

There are currently only a few existing systems that can handle DRM. These technologies all use rights management utilities, software and transaction frameworks that are extrinsic to the content. As a result, these systems require that users either download or have otherwise installed a special piece of software that handles the encryption/decryption and playback of the content, as well as the commercial transaction and usage rights purchasing framework surrounding the content.

As a result, each time the user receives digital media controlled using a previously unused DRM system, the user must download new DRM software which allows the digital media to be viewed. This software will also handle the transaction that needs to be performed, such as payment of a fee, in order to allow the digital media to be viewed. As a result, the user will typically end up with several different DRM software applications that are required to handle digital media controlled by different parties.

This situation is exacerbated by the fact that the user will typically already have one or more software applications, such as Real PlayerTM, or Windows Media PlayerTM that are capable of displaying the digital media once it is decoded.

Accordingly, with the DRM systems operating in the current fashion, there is a large redundancy of application software. This in turn leads to difficulties in distributing digital media in a controlled manner, in particular because parties may not have the application software required to view or create the controlled media. This approach discourages users from using current DRM-protected content and results in a detriment to potential commercial return for rights-owners.

### BRIEF SUMMARY OF THE INVENTION

The present invention relates to a method and apparatus for displaying content and in particular, to digital rights management methods and apparatus.

In a first broad form the present invention provides a method of displaying content to a user, the content being formed from a sequence of data frames, each data frame being encoded using a predetermined algorithm, the sequence of data frames including at least one criteria frame indicating one or more criteria to be satisfied in order to allow at least some of the content to be displayed, the method including:

i) Determining if the next data frame is a criteria frame; and, ii) In response to a successful determination;

(1) Determining the one or more criteria;

(2) Comparing the one or more criteria to user data, the user data indicating whether the criteria are satisfied for the respective user;

(3) Decoding a number of the following data frames in response to a successful comparison; and,

(4) Displaying the content contained therein.

Typically, if the first one or more data frames do not include a criteria frame, the method further includes the steps of:

a) Decoding the first one or more data frames; and,

b) Displaying the content contained therein.

The method usually includes determining the number of following data frames to decode by decoding all the following data frames in sequence until the next criteria frame is reached. However, alternative techniques may also be used to control the number of data frames that are decoded, as will be described below. These additional techniques may be used either instead of, or in conjunction with, above described technique.

The method usually further includes:

a) Displaying selected ones of the one or more criteria to the user, so as to allow the user to accept or reject the criteria; and,

b) Comparing the one or more criteria to the user data in response to acceptance of the criteria.

The method may therefore include determining the number of following data frames to decode in accordance with input commands received from the user.

The criteria preferably includes the payment of funds, the user data indicating the balance of funds available for the respective user, the method including determining the comparison to be unsuccessful if insufficient finds are available. Alternatively, instead of payment requirements, the criteria could include requirements such as the provision of a digital signature, a password, or the like, the correct response to predetermined questions, or any other requirement.

In the case of payment, if insufficient funds are available, the method typically includes the steps of:

a) Receiving transaction details from the user;

b) Transferring the transaction details to a remote transaction system, the remote transaction system being adapted to authorize the transaction;

c) Update the user data based on the transaction; and,

d) Re-compare the one or more criteria to the user data.

The method is preferably implemented using an end station. In this case, the method of comparing the indicated criteria usually includes the steps of:

i) Transferring an indication of the criteria from the end station to a base station via a communications system, the base station being adapted to:

(1) Compare the indicated criteria to user data, the user data indicating whether the criteria are satisfied for the respective user; and,

(2) Generate a notification in response to a successful comparison; and,

ii Monitor for the notification; and,

iii) In response to the notification decode a number of the following data frames and display the content contained therein.

In this case, the method can include determining the number of following data frames to decode by decoding a number of the following frames in accordance with a predetermined number specified in the notification generated by the base station, the base station generating the predetermined number based on the user data.

The method further usually includes the steps of:

a) Generating an identifier that uniquely identifies the user;

b) Transferring the identifier from the end station to the base station together with the indication of the criteria, the base station using the identifier to select the user data corresponding to the respective user.

Preferably, the content includes video and/or audio content. In this case, the sequence of data frames can be in the form of a video stream. Alternatively, the techniques can also be applied to discrete data files.

In a second broad form the present invention provides computer executable code representing content to be displayed to a user, the computer executable code including a sequence of data frames, each data frame being encoded using a predetermined algorithm, the sequence of data frames including at least one criteria frame indicating one or more criteria to be satisfied in order to allow at least some of the content to be displayed, the computer executable code being adapted to cause a suitably programmed processor to:

i) Determine if the next data frame is a criteria frame; and,

ii) In response to a successful determination;

(1) Determine the one or more criteria;

(2) Compare the one or more criteria to user data, the user data indicating whether the criteria are satisfied for the respective user;

(3) Decode a number of the following data frames in response to a successful comparison; and,

(4) Display the content contained therein.

Accordingly, the computer executable code causes a suitably programmed processing system to perform the method of the first broad form of the invention.

In a third broad form the present invention provides a computer program product including computer executable code for causing an end station to display content to a user, the content being formed from a sequence of data frames, each data frame being encoded using a predetermined algorithm, the sequence of data frames including at least one criteria frame indicating one or more criteria to be satisfied in order to allow at least some of the content to be displayed, the computer executable code being adapted to cause the end station to:

i) Determining if the next data frame is a criteria frame; and,

ii) In response to a successful determination;

(1) Determining the one or more criteria;

(2) Comparing the one or more criteria to user data, the user data indicating whether the criteria are satisfied for the respective user;

(3) Decoding a number of the following data frames in response to a successful comparison; and,

(4) Displaying the content contained therein.

In this case, the computer program product causes an end station to operate in accordance with the method of the first broad form of the invention, when presented with the computer executable code according to the second broad form of the invention.

Further, the computer program product typically includes a codec (compressor/decomposer), the codec being adapted to co-operate with media player applications software implemented by the end station.

In a fourth broad form the present invention provides an end station for displaying content to a user, the content being formed from a sequence of data frames, each data frame being encoded using a predetermined algorithm, the sequence of data frames including at least one criteria frame indicating one or more criteria to be satisfied in order to allow at least some of the content to be displayed, the end station including:

a) A display;

b) A processor, the processor being adapted to:

i) Receive the content;

ii) Determine if the next data frame is a criteria frame; and,

iii) In response to a successful determination;

(1) Determine the one or more criteria;

(2) Compare the one or more criteria to user data, the user data indicating whether the criteria are satisfied for the respective user;

(3) Decode a number of the following data frames in response to a successful comparison; and,

(4) Display the content contained therein.

Typically, the end station further includes a communications port for coupling to a communications system, the end station being adapted to perform the method of the first broad form of the invention.

This may be achieved by having the end station implement the computer program product of the third broad form of the invention.

In a fifth broad form the present invention provides a method of controlling the display of content to a user at an end station, the content being formed from a sequence of data frames, each data frame being encoded using a predetermined algorithm, the sequence of data frames including at least one criteria frame indicating one or more criteria to be satisfied in order to allow at least some of the content to be displayed, the method including:

a) Receiving an indication of the criteria from the end station;

b) Comparing the indicated criteria to the user data to determine if the criteria are satisfied;

c) Generating a notification in response to a successful comparison;

d) Transferring the notification to the end station, the end station responding to the notification to:

i) Decode a number of the following data frames; and,

ii) Display the content contained therein.

In this case, the end station is usually adapted to generate an identifier that uniquely identifies the end station and transfer the identifier to the base station together with the indication of the criteria, the method then usually includes using the identifier to select the user data corresponding to the respective user.

The method usually further includes:

a) Determining the number of following data frames to decode based on the user data; and,

b) Transferring the number to the end station together with the notification.

The criteria typically includes the payment of funds, the user data indicating the balance of funds available for the respective user and the method including generating the notification if sufficient funds are available.

If insufficient funds are available the method preferably includes:

a) Generating an insufficient funds notification;

b) Transferring the insufficient funds notification to the end station, the end station being adapted to respond to the insufficient funds notification by:

i) Displaying a transaction screen to the user, allowing the user to enter transaction details; and,

ii) Transferring the transaction details to a remote transaction system via the communications port, the remote transaction system being adapted to authorize the transaction and transfer an indication of the authorization to the base station;

c) Receiving the indication of the authorization;

d) Updating the user data;

e) Re-comparing the criteria to the transaction content; and,

f) Generating the notification in response to a successful comparison.

In a sixth broad form the present invention provides a computer program product including computer executable code for causing a base station to control the display of content to a user at an end station, the content being formed from a sequence of data frames, each data frame being encoded using a predetermined algorithm, the sequence of data frames including at least one criteria frame indicating one or more criteria to be satisfied in order to allow at least some of the content to be displayed, the computer executable code being adapted to cause the base station to:

a) Receiving an indication of the criteria from the end station;

b) Comparing the indicated criteria to the user data to determine if the criteria are satisfied;

c) Generating a notification in response to a successful comparison;

d) Transferring the notification to the end station, the end station responding to the notification to:

i) Decode a number of the following data frames; and,

ii) Display the content contained therein.

Accordingly, the computer program product is preferably adapted to cause the base station to perform the method of the fifth broad form of the invention.

In a seventh broad form the present invention provides a base station for controlling the display of content to a user at an end station, the content being formed from a sequence of data frames, each data frame being encoded using a predetermined algorithm, the sequence of data frames including at least one criteria frame indicating one or more criteria to be satisfied in order to allow at least some of the content to be displayed, the base station including:

a) A store for storing user data;

b) A processor, the processor being adapted to:

i) Receive an indication of the criteria from the end station;

ii) Compare the indicated criteria to the user data to determine if the criteria are satisfied;

iii) Generate a notification in response to a successful comparison;

iv) Transfer the notification to the end station, the end station responding to the notification to:

(1) Decode a number of the following data frames; and,

(2) Display the content contained therein

Accordingly, in this case, the base station preferably includes a communications port for coupling to a communications system, the base station being adapted to communicate with the end station via the communications port.

The base station is therefore preferably adapted to perform the method of the fifth broad form of the invention.

In an eighth broad form the present invention provides a system for displaying content to a user at an end station, the content being formed from a sequence of data frames, each data frame being encoded using a predetermined algorithm, the sequence of data frames including at least one criteria frame indicating one or more criteria to be satisfied in order to allow at least some of the content to be displayed, the system including:

a) An end station according to the fourth broad form of the invention;

b) A base station according to the seventh broad form of the invention; and,

c) A communications system for interconnecting the end station and the base station.

In a ninth broad form the present invention provides a method of generating content to be displayed to a user at an end station, the content being formed from a sequence of data frames, each data frame being encoded using a predetermined algorithm, the sequence of data frames including at least one criteria frame indicating one or more criteria to be satisfied in order to allow at least some of the content to be displayed, the method including:

a) Selecting the content to be displayed;

b) Encoding the content as a number of data frames using a predetermined encoding algorithm;

c) Specifying the one or more criteria to be included in the criteria frames;

d) Generating the one or more criteria frames in accordance with the specified criteria, the criteria frames being encoded using the predetermined algorithm; and,

e) Generating the sequence of data frames in accordance with the content, the sequence of data frames including the one or more criteria frames.

Typically the criteria including details of one or more of:

a) The number of criteria frames to be included;

b) The relative separation of the criteria frames in the sequence of data frames;

c) Payment content, including an indication of the payment required to display a predetermined amount of content; and,

d) Information describing the author of the content.

This latter criteria relating to information regarding the author of the content is provided to allow the base station to effectively distribute any monies garnered from the transaction.

In a tenth broad form the present invention provides a computer program product including computer executable code which when implemented by a suitable processing system causes the processing system to generate content to be displayed to a user at an end station, the content being formed from a sequence of data frames, each data frame being encoded using a predetermined algorithm, the sequence of data frames including at least one criteria frame indicating one or more criteria to be satisfied in order to allow at least some of the content to be displayed, the computer executable code causing the processing system to:

a) Allow a user to select the content to be displayed;

b) Encode the content as a number of data frames using a predetermined encoding algorithm;

c) Allow the user to specifying the one or more criteria to be included in the criteria frames;

d) Generate the one or more criteria frames in accordance with the specified criteria, the criteria frames being encoded using the predetermined algorithm; and,

e) Generate the sequence of data frames in accordance with the content, the sequence of data frames including the one or more criteria frames.

In an eleventh broad form the present invention provides a processing system adapted to generate content to be displayed to a user at an end station, the content being formed from a sequence of data frames, each data frame being encoded using a predetermined algorithm, the sequence of data frames including at least one criteria frame indicating one or more criteria to be satisfied in order to allow at least some of the content to be displayed, the processing system including:

a) An input for receiving commands from a user;

b) A processor adapted to:

i) Receive the content to be displayed;

ii) Encode the content as a number of data frames using a predetermined encoding algorithm;

iii) Receive input commands from the user specifying the one or more criteria to be included in the criteria frames;

iv) Generate the one or more criteria frames in accordance with the specified criteria, the criteria frames being encoded using the predetermined algorithm; and,

v) Generate the sequence of data frames in accordance with the content, the sequence of data frames including the one or more criteria frames.

### BRIEF DESCRIPTION OF THE DRAWINGS

An example of the present invention will now be described with reference to the accompanying drawings, in which:

FIG. 1 is a schematic diagram of a system for implementing the present invention;

FIG. 2 is a schematic diagram of one of the base station processing systems of FIG. 1;

FIG. 3 is a schematic diagram of one of the end stations of FIG. 1;

FIGS. 4A, 4B and 4C are a flow diagram outlining the operation of the system of FIG. 1 to display the content of an encoded media file;

FIGS. 5 is a schematic diagram of a media file encoded using the system of FIG. 1; and,

FIG. 6 is a flow diagram outlining the operation of the system of FIG. 1 to encode a media file.

### DETAILED DESCRIPTION OF THE INVENTION

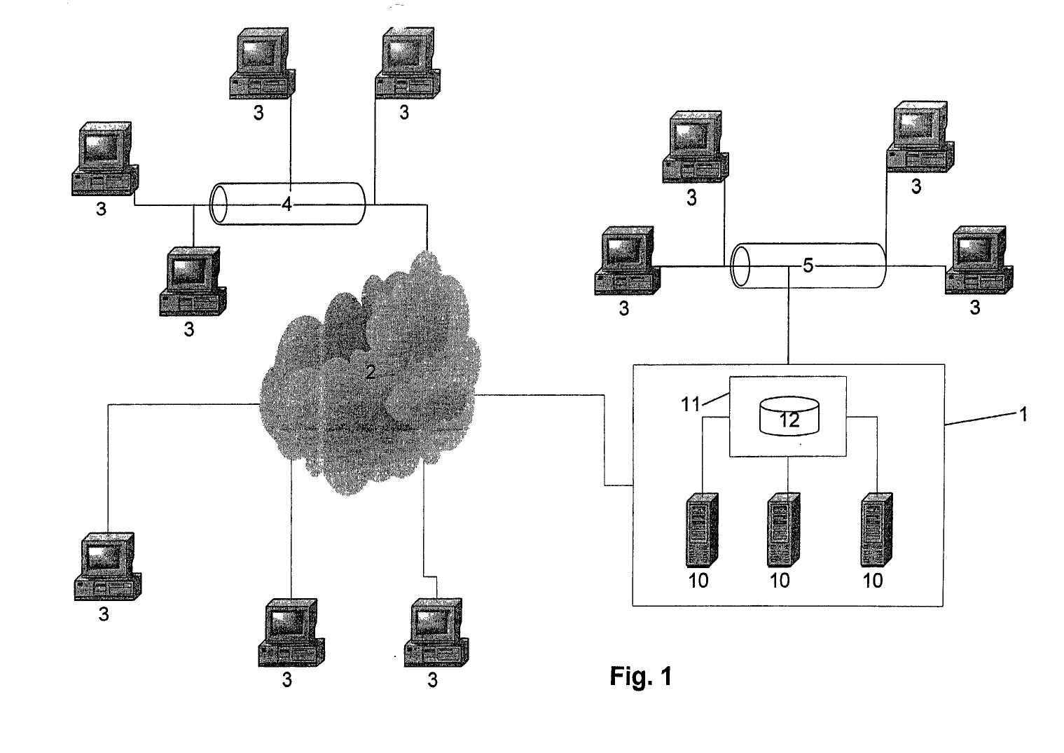

FIG. 1 shows a system that is adapted to provide DRM services, including the creation and playback of encoded media files. In particular, the system is adapted to create encoded media files from provided information and then control access to the encoded media files such that the information can only be presented once one or more predetermined criteria have been satisfied.

As shown, the system includes a base station 1 coupled to a number of end stations 3 via communications networks 2, 4, 5.

The communications networks 2, 4, 5 may consist of any suitable communications networks that allow the end stations 3 to connect to the base station 1. Thus for example, the networks could be formed from Local Area Networks (LANs), Wide Area Networks (WANs), or the like, and may be wired or wireless networks.

In this particular example, the communications network 2 is the Internet, which allows the end stations to access the base station 1 from remote locations, which may be distributed world-wide. In addition to this, the communications networks 4, 5 are typically LANs, such as Ethernet LANs. The LAN 4 allows the end stations 3 connected thereto, to access the base station 1 via the Internet 2, whereas the LAN 5 allows direct access to the base station 1. Accordingly, the LAN 5 would typically be located at the same geographical location as the base station 1.

As shown, the base station 1 typically includes one or more processing systems 10 coupled to a data store 11. The data store 11 may be any form of data store, such as a hard-drive, electronic memory, or the like, which is adapted to store at least one database 12 containing user data, as will be described in more detail below.

In use, the base station 1 operates to create encoded media files in accordance with the present invention, as well as to control whether users of the end stations 3 can access the encoded media files. In order to do this, when one of the end stations attempts to access an encoded media file, the end station 3 must obtain authorization from the base station 1 before the data can be displayed.

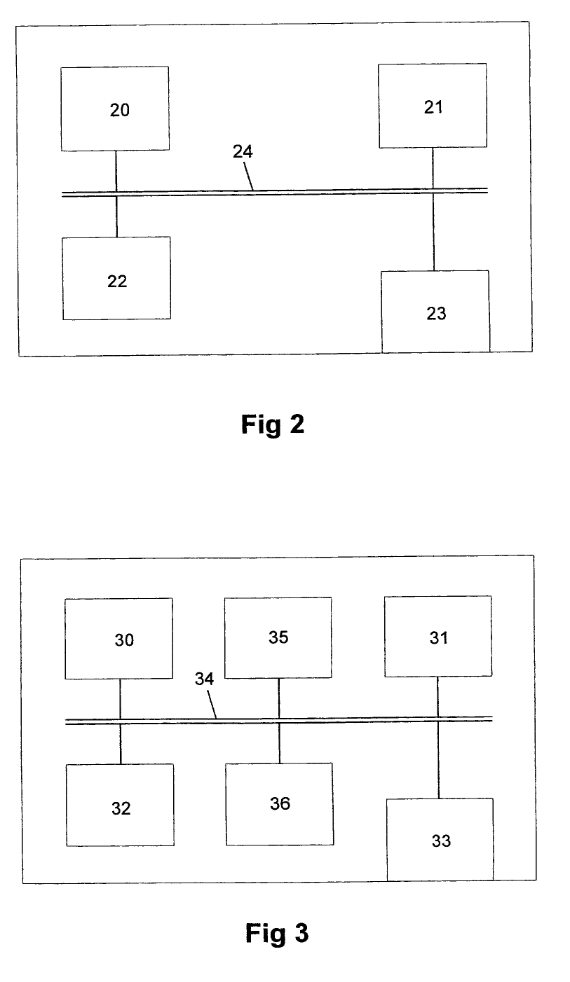

Accordingly, the processing system 10 must be capable of receiving details of the content to be displayed, determine whether access to the content should be provided, and provide an indication of this to the respective end station 3. An example of a suitable processing system is shown in FIG. 2, and this includes a processor 20, a memory 21, an Input/Output (I/O) device 22 and an interface 23, which are coupled together via a bus 24.

It will be appreciated from this that the processing system may be any form of processing device, a personal computer, a lap-top or the like that is executing suitable applications software and that is capable of connecting to the end stations 3 via the communications networks 2, 4, 5. Typically however in view of the need to provide large amounts of data processing and control, the processing systems 10 are formed from network servers, such as web servers, or the like.

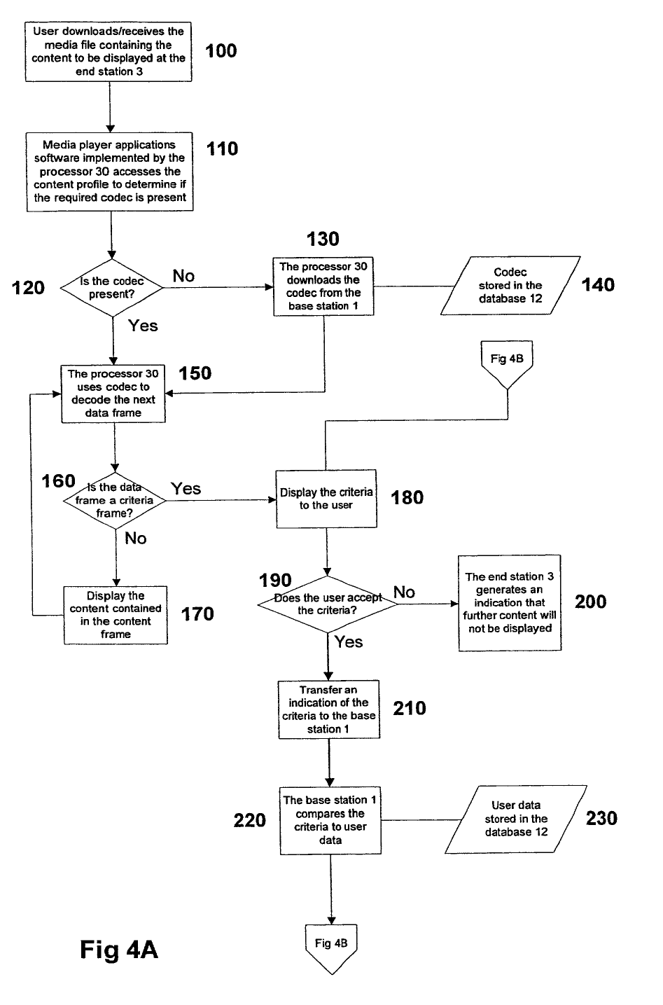

Similarly, it will be appreciated that the end stations 3 must also be capable of communicating via the communications networks 2, 4, 5, as well as displaying the content contained in the encoded media files. Accordingly, each end station 3 typically includes a processor 30, a memory 31, an I/O device 32, such as a screen and keyboard, and an interface 33, which are coupled together via a bus 34, as shown in FIG. 3. In this example, the interface 33 is used to connect the end station 3 to either the Internet 2, or the LANs 4, 5 and accordingly, will be formed from a modem, Ethernet card, or the like, as appropriate.

Accordingly, the end stations 3 could be formed from a personal computer, a lap-top, palm-top, an Internet terminal, an Internet enabled television, or the like, which is executing applications software allowing content to be displayed. This software, is usually in the form of a media player such as, RealPlayerTM, Windows Media PlayerTM, QuickTime, or the like.

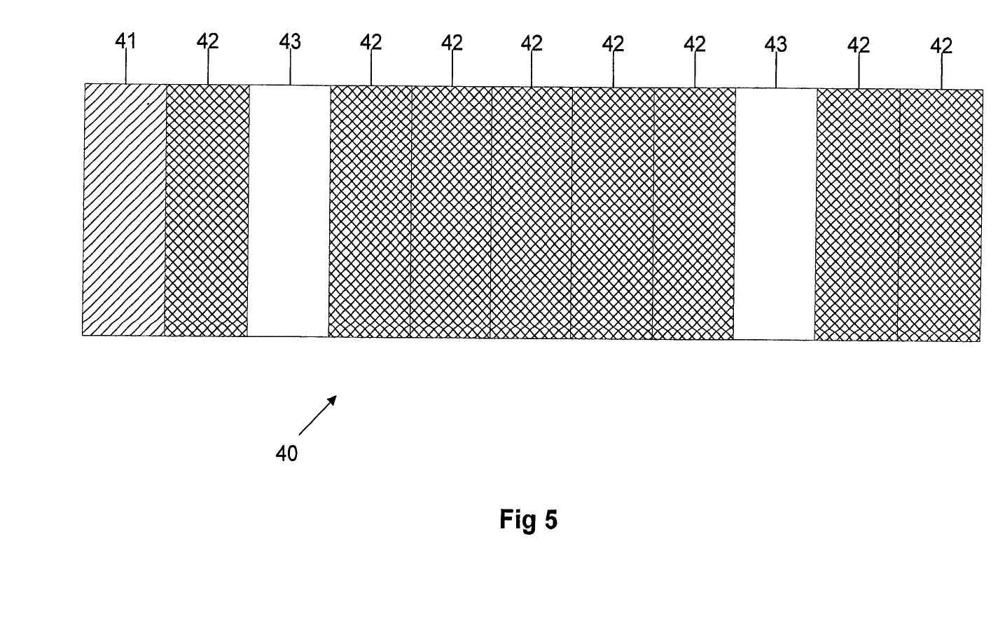

In general, the system operates to generate an encoded media file for any content that is to be distributed in a controlled manner. An example of an encoded media file is shown in FIG. 5.

As shown, the encoded media file 40 is formed from a sequence of data frames, including a content profile frame 41, one or more content frames 42 and one or more criteria frames 43.

The content profile frame 41 specifies details of the contents of the encoded media file, such as the nature of the encoding, the date the file was created, the nature of the contained content, or the like.

The content frames 42 contain the content and are encoded using a predetermined algorithm, such as an RSA encryption algorithm.

Finally, the criteria frames 43 include details of any criteria that must be fulfilled in order for the content to be displayed. The criteria can be almost any requirement desired by the owner of the content but generally includes the requirement for some form of payment, as will be described in more detail below.

It will be appreciated from the above that the media file may be either a discrete file, or alternatively may be provided in the form of a data stream such as an encoded video stream.

In general terms, when an individual wishes to distribute content in a controlled fashion, the content is provided to the base station 1 together with details of the criteria that are to be used to control the distribution of the content.

The content is then divided into a number of content frames 42, each of which is encoded using the predetermined encryption algorithm. Once this has been completed, the base station operates to generate the criteria frames 43 in accordance with the specified criteria. At this point the base station operates to position one or more criteria frames 43 between the content frames, as shown. The positioning of the criteria frames is controlled in accordance with the criteria as will be explained in more detail below.

Finally, the base station generates the content profile frame 41, to complete the encoded media file.

When an end station 3 attempts to present the content of the encoded media file, the end station 3 will execute applications software, such as Windows Media PlayerTM. The media player will open the content profile frame and determine the type of encryption used. If this type of file has not been previously encountered, it is typically necessary for the media player to download a codec from the end station 3 to allow the encoded frames to be decoded.

The media player will then operate to decode each data frame in turn. If the data frame is a content frame 42, then content of the frame is displayed to the user. If however the data frame is a criteria frame, the end station 3 and the base station 1 will co-operate to determine if the criteria specified therein are satisfied. If the criteria are satisfied, then the subsequent content frames will be decoded and displayed.

However, if the criteria are not satisfied, then the codec prevents further content frames being decoded, such that no further content can be displayed to the user.

Accordingly, it will be appreciated that the criteria can be, for example, the payment of a fee. In this case, the codec will only decode the content frames once the base station 1 confirms that the payment has been received. In addition to this, the payment may only cover the presentation of say 5 minutes of content. In this case, the codec will only decode a sufficient number of content frames to satisfy the fee paid.

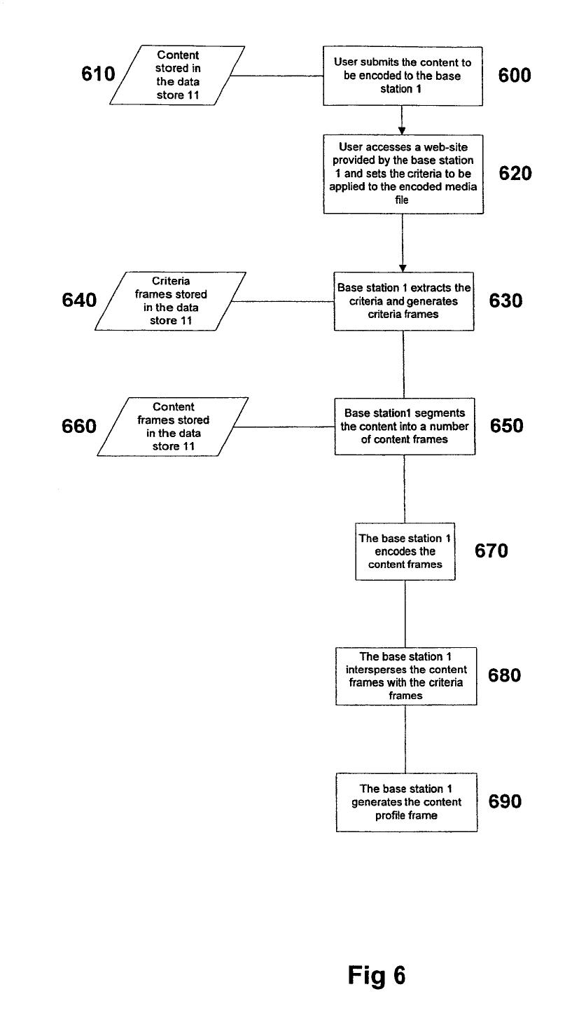

Firstly, creation of an encoded media file will be described, with respect to the flow chart shown in FIG. 6.

Initially, as outlined above, the user provides the content to be encoded to the base station 1, as shown at step 600, with the content being stored in the data store 11, as shown at 610. This transfer of the content can be achieved in a number of ways, such as by electronic submission via the Internet, or by physical transfer of the relevant data.

In any case, the exact manner in which the data is provided is unimportant as long as the data remains secure. Thus, for example, the base station 1 may provide a public key of an RSA encryption public-private key pair, allowing users of the end station 3 to encrypt the data. In this case, as the base station 1 alone has the private key, only the base station 1 can decrypt the data.

The user can then access a web-site generated on the base station 1, to set the criteria that is used to control the presentation of the content, as shown at step 620. Anyone of a number of different criteria can be set, including requiring the provision of:

A fee to view all the content; A fee to view a predetermined amount of content;

A password;

Authorization of the author;

The provision of a digitally signed viewing authorization.

Additional other similar criteria may also be set, as will be appreciated by persons skilled in the art.

The criteria are set by entering the details on the web-site, and this is typically achieved using a form with prompts for appropriate information.

At step 630, the processing system 10 of the base station 1 will extract the criteria generated by the user, and use these to generate criteria frames. The criteria frames will include an indication of the criteria, which are again typically set in a predetermined format. Thus, for example, in the case of fee payments, the criteria will specify the amount of the fee, and how much content will be displayed, such as $1 per minute, or the like.

The criteria frames are temporarily stored in the data store 11, as shown at 640.

The processing system then accesses the content stored in the database 12 and operates to segment the content into a number of content frames at 650 and 660. The content frames are encoded at 670, before the processing system intersperses the content frames with the criteria frames at 680.

The positioning of the criteria frames is controlled in accordance with the criteria. Thus, for example, if the payment of a fee is required to view a predetermined amount of content, then the criteria frames will be separated by a number of content frames equivalent to the predetermined amount of content. Accordingly, as will be described in more detail below, each time a criteria frame is reached during display of the content, the system will operate to check the criteria have been satisfied before playing further content.

Examples of some of the circumstances that influence the distribution of criteria frames are set out below:

A single criteria frame may be used if a one off payment is used to allow all the content to be viewed.

A user profile may store membership subscription information that satisfies the criteria frame, in which case there will only need to be one criteria frame at the head of the file.

The separation of criteria frames may be set according to the sensitivity of the content to unauthorized viewing, such that more frequent criteria checks may be made if the playback purchase price is high, or high-per-minute, for example.

The criteria may indicate that the content is only playable during a particular time window (that is, between a certain two pre-designated times). In this case, the criteria frames may be evenly dispersed through the content such that a regular check is made to ensure that the current time is between the two pre-designated times.

The content file may be of a type that is logically divisible into segments that may represent episodes or other types of content segments that are purchased separately. In this case, the criteria frame would be inserted at the head of each “episode”.

At step 690 the base station 1 generates a content profile frame to complete the media file. The content frame includes details of the codec required to decode the data frames, the location from which the codec can be downloaded, as well other additional information including, but not limited to the date of creation, the nature of the content

The completed media file can then be either stored at the base station 1, or returned to the user for subsequent distribution.

In general, when the base station 1 operates to encode both the criteria and content frames this is achieved using a predetermined encryption algorithm, as mentioned above, such as an RSA encryption algorithm. However, in addition to this, additional adaptive processing may also be used when generating the encoded frames. This may include for example, in frame compression (intra-frame compression) such as JPEG compression, interframe compression, and the use of a discrete cosine transformation that operates to compress data between the frames based on the direction of change of graphical images (as is used in MPEG-1, MPEG-2 compression algorithms).

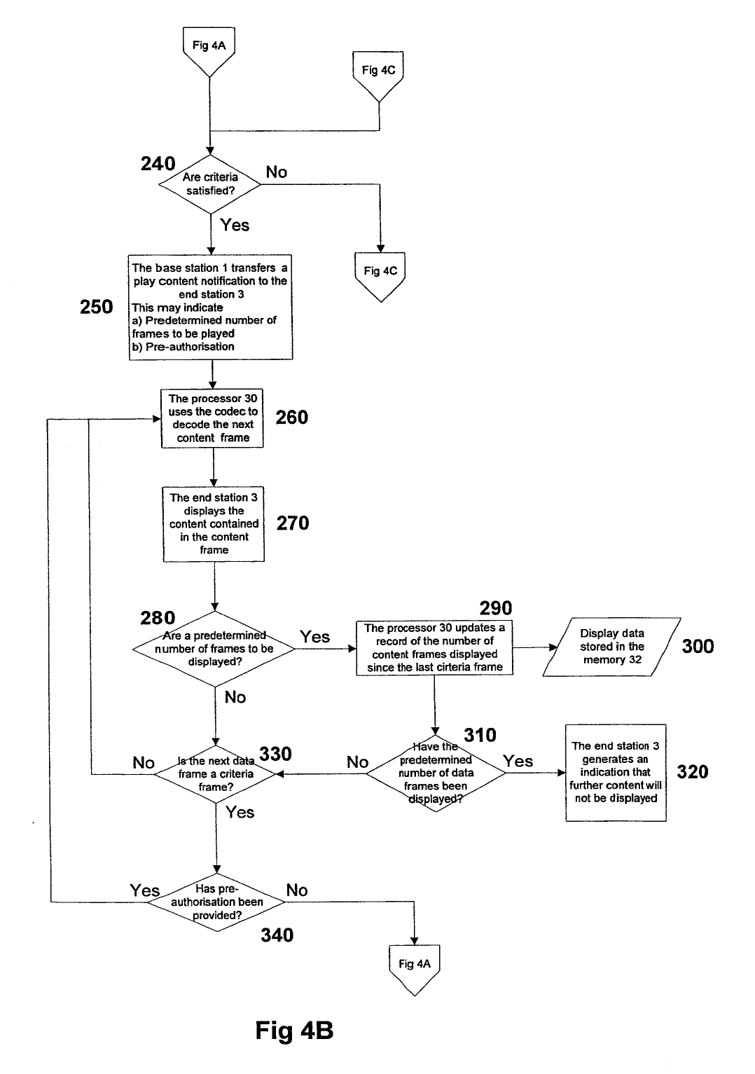

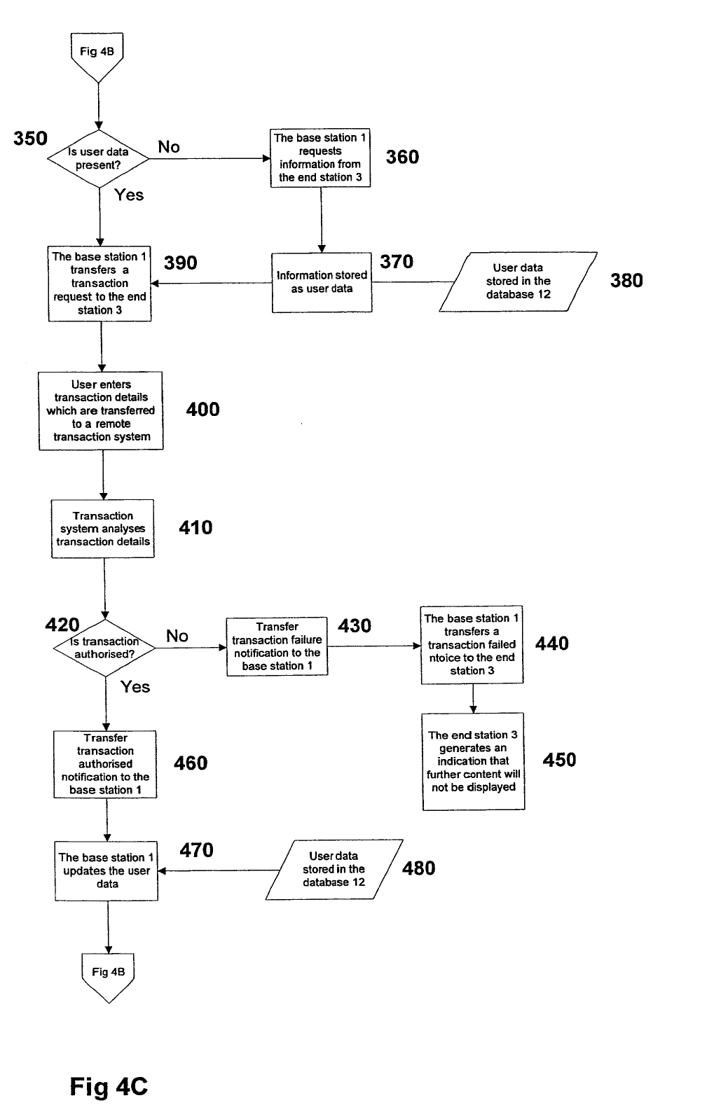

Operation of the system to control the display of content from a media file encoded as described above will now be described with reference to the flow diagrams shown in FIGS. 4A, 4B and 4C.

Firstly, as shown at step 100, the user obtains the encoded media file. This may achieved for example by downloading the encoded media file from the base station 1, or alternatively receiving the encoded media file via e-mail, via download from an alternative web-site, via floppy disk, CD-ROM, DVD-ROM or the like.

In order to view the content of the files, the end station 3 must be provided with application software that is capable of decoding each data frame and displaying the content contained therein. As outlined above, this is typically achieved using a standard media player, such as Windows Media Player, which is provided with an appropriate codec.

The codec is formed from computer executable code that co-operates with the media player to allow content to be decoded. This is achieved by having the algorithm required to decode the content incorporated into the codec. This means that each codec is specific to a respective encoding scheme. Thus, the codec required to decode media files generated in accordance with the invention will not be able to decode media files from other sources.

However, the codec is formed from a small portion of code, typically no more than a few hundred kilobytes, and it can therefore be readily downloaded and integrated into the existing media player system as required.

Accordingly, when the end station 3 receives the media file containing the content to be displayed it will attempt to decode the encoded data frames using the media player software.

In order to do this an association will be created between the media file type and Media Player applications software, which may be any one of a number of different Media Players, such as Windows Media PlayerTM, Real PlayerTM or the like. Once the association has been created, or has been detected by the processor 30, which will operate to activate the media player applications software.

The first stage is for the media player to access the content profile frame located at the start of the media file, which specifies the type of encoding used to encode the media file, step 110.

The media player uses this information to determine if the correct codec is currently available within the end station 3, at step 120. If not, the processor 30 operates to access the content profile frame, which as mentioned above, includes details of a location, such as a URL (Universal Resource Locator) from which the codec can be downloaded. While the codec may be available from any source, the codec is typically at least available for download from the base station 1, as shown at 130 and 140.

Accordingly, the processor 30 downloads the codec from the database 12 via one of the communications network 2, 4, 5 as appropriate. Once the codec is downloaded it is installed, allowing the Media Player to utilize the decryption algorithm contained therein.

Once the correct codec is operational, the processor 30 operates to decode the next data frame in the digital media file using the codec, as shown at step 150. In order to do this, the media player utilizes the decryption algorithm contained within the codec, to decode the data frame.

Once the data has been decoded, the processor 30 determines if the data frame is a criteria frame, at step 160. If not, the processor 30 operates to cause the content contained in the content frame 42 to be displayed using the I/O device 32, at step 170. This may include for example displaying graphics on a display, as well as presenting sound through an audio system. At this point the processor 40 returns to step 150 to decode the next data frame.

It will be appreciated that the above describes the decoding of each data frame discretely. However, this may not be possible if the content of the content frames are interconnected, for example by cosine transformations. In this case, the processor 30 is adapted to decode the content frames in such a way as to allow the content of the frames to be correctly displayed.

In any event, this process will be continued until a criteria frame is reached at step 160.

At this point, the processor 30 moves to step 180 and operates to display the criteria contained within the criteria frame to the user. The criteria will indicate to the user what factors must be satisfied in order for the remaining content to be viewed.

As set out above, this may include for example, the provision of a password, or the like. However generally the criteria will require the payment of a fee to view the content contained within the remaining content frames, and the remainder of this example will describe the operation of the system in such circumstances.

Accordingly, the processor will cause an indication of the required fee to be displayed to the user of the end station 3 at step 180. This may constitute the payment of a fee to view a particular amount of time, such as the payment of $1.00 to view a minute's worth of content, or alternatively may represent a flat fee to allow the remaining content to be viewed

The processor 30 then requests that the user indicate whether the criteria are accepted. If the processor 30 determines that the criteria are not accepted by the user at step 190, then the end station 3 generates an indication that further content will not be displayed at step 200.

If however the criteria are accepted, then the processor 30 operates to transfer an indication of the criteria to the base station 1, at step 210. When doing this, the processor 30 will also transfer an indication of any restrictions on the acceptance of the criteria. Thus for example, in the case in which the content is viewed on a pay per time basis, the user may indicate that they wish to view subsequent content up to a maximum financial value. Alternatively, the user may specify that they wish to view all remaining content regardless of the cost.

In addition to this, the processor 30 operates to generate an identifier that is unique to the respective end station. This identifier will therefore typically be based on information specific to the respective end station 3, such as the MAC (Media Access Control) address, the serial number of the processor 30, or the like. This will generally be combined with additional information, such as an identifier provided with the codec. This is then encoded using a predetermined algorithm, such as a hash function, which may again typically be supplied to the end station 3 as part of the codec. Alternatively, the algorithm could be downloaded from the base station 1 directly, as required.

The identifier is transferred to the base station 1 which operates to use the identifier to access user data stored in the database 12, as shown at 220 and 230. The user data indicates various information including the current status of any financial payments, or the like.

Accordingly, at step 240, the processor 20 of the base station 1 operates to compare the criteria received from the end station 1 to the user data, to determine if the criteria are satisfied.

Thus, for example, if the criteria require the payment of a fee, the processor 20 will compare the fee required to the funds currently available on the user's account. If sufficient funds are available, then, as the user has already accepted the criteria, the processor 20 can operate to debit the required funds from the user's account. The base station 1 will then generate a notification indicating that further content can be displayed at step 250, as will be explained in more detail below.

If the comparison is unsuccessful, so that the criteria are not satisfied, the processor 20 proceeds to step 350 to confirm that user data is present. The user data may not be present for example if this is the first time the system is being used by the respective end station, and this will depend on the manner in which the user data is collected by the base station 1.

Thus, for example, the user may be requested to enter certain information when the codec is initially downloaded. In this case, it is impossible for user data not to be present at this stage.

However, alternatively, the user can be asked to provide information only when it is first required. In this case, as shown at step 360, as no user data is present, the base station 1 requests that the user provides the required information. This will typically be achieved by transferring the user to a secure web-page, typically via a SSL (Secure Socket Layer) connection, that includes a form in which the required information can be entered. The user enters the data in the form, including an indication of whether they wish to maintain an account at the base station 1 for subsequent payments to view content.

The information is then used by the processor 20 to generate the user data, which is stored in the database 12, together with the unique identifier, to allow the user data to be accessed in the future. This is shown at 370 and 380.

At step 390, as the criteria have not yet been satisfied (as the provision of user data will not generally also include any fee payment) the base station 1 generates a transaction request that is transferred to the end station 3. The user then enters transaction details that are transferred to a remote transaction system (not shown) via a secure SSL connection at step 400. In the case, the transaction details can be transferred via the base station 1, or instead can be transferred directly to the transaction system for additional security. This latter case ensures that no third parties (including the base station 1) other than the user and the transaction system have access to the credit card details.

The remote transaction system used will depend on the nature of the transaction. Thus for example, if the user provides credit card details, the transaction system will be a credit card authorization system. The transaction system analyses the transaction details at step 410 and then operates to authorize or reject the transaction, in the normal way.

If the transaction is not authorized at step 420 the transaction system will generate a transaction failure notification that is transferred to the base station 1 as shown at step 430. The base station 1 will then transfer a transaction failed notification to the end station 3 at step 440, which in turn causes the end station 3 to generate an indication that further content will not be displayed at step 450.

Alternatively, if the transaction is authorized at step 420 the transaction system operates to transfer a transaction authorized notification to the base station 1 at step 460. This will typically include an authorization number that can be used to verify the transaction in the future.

Once this has been completed, the base station 1 operates to update the user data stored in the database 12 at 470 and 480, to reflect the finds now available to the user. The processor 20 then checks that the criteria are now satisfied at step 240.

Once the criteria are satisfied, the base station 1 debits the user's account data to reflect the money the user has agreed to spend, and generates a play content notification, which is transferred to the end station 3, at step 250.

The play content notification may include an indication of the number of content frames that are to be displayed, or a pre-authorization depending on the implementation.

Thus, typically the content of the media file is divided into a number of portions that are separated by respective criteria frames. In absence of other instructions, the system will allow the user to view the next content portion when the criteria in a given criteria frame are satisfied. When the next criteria frame is reached, new criteria can be displayed, allowing the user to authorize the viewing of the next portion.

However, as an alternative, when the user has accepts the criteria at step 190, the user may indicate that they are willing to pay for $5.00 worth of content, which may cover several content portions. In this case, the base station will operate to calculate how much further content may be displayed for this amount of money, and the number of content frames to which this corresponds. The base station 1 will then indicate the number of data frames in the play content notification.

Similarly, the user may indicate that they wish to view the next 5 minutes worth of content, in which case the base station 1 again calculates the number of content frames to which this corresponds.

The user may also indicate that they wish to review all the remaining content portions, in which case the processor generates a pre-authorization indication if sufficient funds are available. The pre-authorization may be transferred to the end station 1 with the play content notification, or alternatively be stored in the user data as will be explained in more detail below.

At step 260 the processor 30 operates to decode the next content frame and display the content contained therein of the frame at step 270.

The processor 30 then before determines whether content from a predetermined number of content frames is to be displayed as shown at step 280. If so, the processor 30 updates the number of frames so far displayed, which is stored in the memory 32 as shown at 290 and 300.

At step 310 the processor then determines if the predetermined number of content frames have been decoded. If the predetermined number of content frames have been decoded the end station 3 generates an indication that further content will not be displayed as shown at step 320.

Otherwise, the processor 30 determines if the next data frame is a criteria frame at step 330. If not, then the processor 30 returns to step 260 and decodes the next content frame.

If however the next data frame is a criteria frame the processor determines at step 320 if pre-authorization has been provided. This may occur if the user has indicated that all further content is to be displayed, or if the user has indicated a predetermined amount of content is to be displayed, and this amount of content has not yet been displayed (as determined at steps 280 to 320 above).

If pre-authorization has been provided the processor 30 again moves on to the next content frame at step 260. It will be realized that if the pre-authorization indication is stored in the user data in the database 12, then it may be necessary for the processor 30 to transfer a pre-authorization query to the base station 1 to determine if pre-authorization is provided.

Otherwise the processor 30 returns to step 180 and displays the criteria to the user thereby requiring the user to accept the criteria to allow the next content portion to be displayed.

Accordingly, in this manner the system can be used to control the display of the content of the media file to the user of the end station 3.

A number of variations to the system can also be implemented, as will be appreciated by persons skilled in the art.

Thus for example at any stage that the end station 3 generates an indication that further content will not be displayed as shown for example at steps 200, 320 and 450, the user could be provided with the option of satisfying the outstanding criteria. Thus for example, if the user's account has run out of finds the user could be provided with the opportunity to make a further transaction. Alternatively, the user may be requested if they desire to see further content, effectively allowing the user to accept so far unaccepted criteria.

Furthermore, the actual configuration of content and criteria frames will depend on the criteria that were set when the content file was generated. Thus for example, the criteria frames can be included at regular intervals throughout the media file to allow the content to be displayed in portions. Alternatively a single criteria frame may be provided at the start of the data file to allow users to make a single one off payment to the entire remaining file.

Furthermore, when the checking of whether the predetermined number of content frames have been displayed (step 310) and the pre-authorization check (step 340) are performed, this could require the processor 30 to obtain information from the user data in the database 12. In this case, the processor 30 would have to request information from the base station 1. In this circumstance, as access to the information could not be controlled by the user, this can add an additional degree of security to the system.

Similarly, this permits once-and-only-once payment for particular media files, if for example the content was encoded such that once the media file has been payed for, this information should be stored in the user profile such that this unique user may continue to play and re-play this content in perpetuity (or an agreed limited number of times).

Furthermore, in the example described above, the user data is accessed using the unique identifier generated by the end station 3. Accordingly, the user data is in fact specific to the end station as opposed to the actual user. Accordingly, if the user's a different end station, different user data will be required. This can be avoided by having the user enter a secret password to allow the user data to be accessed. However, this has the disadvantage that the password must be remembered by the user, and if another user obtained the password, they could fraudulently user the genuine users account.

A further option available is for the system to only charge users once for viewing content, so that once the payment has been made a single time, the content can be repeatedly viewed free of charge.

In order to implement this, once the criteria have been accepted and satisfied a first time, an indication of this is stored in the user data. In this case, the user data would include an identifier specific to the respective media file. Accordingly, when the user next attempts to access the user file, and the end station 3 transfers the criteria to the base station 1, the base station 1 will access the user data and determine the criteria have been previously satisfied. The content can then be displayed without requiring any further payment.

In this case, it will be appreciated that if the identifier generated by the end station 3 is end station specific, this advantageously ensures that the content can only be viewed on that respective end station. This overcomes the problem of having individuals decoding the media file and then transferring the media file to other users to allow them to view the content without charge.

Persons skilled in the art will appreciate that numerous variations and modifications will become apparent. All such variations and modifications which become apparent to persons skilled in the art, should be considered to fall within the spirit and scope that the invention broadly appearing before described.

What is claimed is:

1. A method of displaying content to a user, the content being formed from a sequence of data frames, each data frame being encoded using a predetermined algorithm, the sequence of data frames including at least one criteria frame indicating one or more criteria to be satisfied in order to allow at least some of the content to be displayed, the method comprising the steps of:
Determining if the next data frame is a criteria frame; and,
In response to a successful determination;
Determining the one or more criteria;
Comparing the one or more criteria to user data, the user data indicating whether the criteria are satisfied for the respective user;
Decoding a number of the following data frames in response to a successful comparison; and,
Displaying the content contained therein.

2. A method according to claim 1, wherein if the first one or more data frames do not include a criteria frame, the method further includes the steps of:
Decoding the first one or more data frames; and,
Displaying the content contained therein.

3. A method according to claim 1, the method including determining the number of following data frames to decode by decoding all the following data frames in sequence until the next criteria frame is reached.

4. A method according to claim 1, the method further including:
displaying selected ones of the one or more criteria to the user, so as to allow the user to accept or reject the criteria; and,
Comparing the one or more criteria to the user data in response to acceptance of the criteria.

5. A method according to claim 4, the method including determining the number of following data frames to decode in accordance with input commands received from the user.

6. A method according to claim 1, the criteria including the payment of funds, the user data indicating the balance of funds available for the respective user, the method including determining the comparison to be unsuccessful if insufficient funds are available.

7. A method according to claim 6, wherein if insufficient funds are available, the method further includes the steps of:
Receiving transaction details from the user;
Transferring the transaction details to a remote transaction system, the remote transaction system being adapted to authorize the transaction;
Update the user data based on the transaction; and,
Re-compare the one or more criteria to the user data.

8. A method according to any of claim 1, the method being implemented using an end station, the method of comparing the indicated criteria including the steps of:
Transferring an indication of the criteria from the end station to a base station via a communications system, the base station being adapted to:
Compare the indicated criteria to user data, the user data indicating whether the criteria are satisfied for the respective user; and,
Generate a notification in response to a successful comparison; and,
Monitor for the notification; and,
In response to the notification decode a number of the following data frames and display the content contained therein.

9. A method according to claim 8, the method including determining the number of following data frames to decode by decoding a number of the following frames in accordance with a predetermined number specified in the notification generated by the base station, the base station generating the predetermined number based on the user data.

10. A method according to claim 8, the method further including the steps of:
Generating an identifier that uniquely identifies the user;
Transferring the identifier from the end station to the base station together with the indication of the criteria, the base station using the identifier to select the user data corresponding to the respective user.

11. A method according to any of claim 1, the content including video and/or audio content.

12. A method according to any of claim 1, the sequence of data frames being in the form of a video stream.

13. A method of displaying content to a user, the method including a sequence of data frames, each data frame being encoded using a predetermined algorithm, the sequence of data frames including at least one criteria frame indicating one or more criteria to be satisfied in order to allow at least some of the content to be displayed.

14. Computer executable code representing content to be displayed to a user, the computer executable code comprising a sequence of data frames, each data frame being encoded using a predetermined algorithm, the sequence of data frames including at least one criteria frame indicating one or more criteria to be satisfied in order to allow at least some of the content to be displayed, the computer executable code being adapted to cause a suitably programmed processor to:
Determine if the next data frame is a criteria frame; and,
In response to a successful determination;
Determine the one or more criteria;
Compare the one or more criteria to user data, the user data indicating whether the criteria are satisfied for the respective user;
Decode a number of the following data frames in response to a successful comparison; and,
Display the content contained therein.

15. Computer executable code representing content to be displayed to a user, the computer executable code including a sequence of data frames, each data frame being encoded using a predetermined algorithm, the sequence of data frames including at least one criteria frame indicating one or more criteria to be satisfied in order to allow at least some of the content to be displayed.

16. A computer program product comprising computer executable code for causing an end station to display content to a user, the content being formed from a sequence of data frames, each data frame being encoded using a predetermined algorithm, the sequence of data frames including at least one criteria frame indicating one or more criteria to be satisfied in order to allow at least some of the content to be displayed, the computer executable code being adapted to cause the end station to:
determine if the next data frame is a criteria frame; and,
In response to a successful determination;
Determining the one or more criteria;
Comparing the one or more criteria to user data, the user data indicating whether the criteria are satisfied for the respective user;
Decoding a number of the following data frames in response to a successful comparison; and,
Displaying the content contained therein.

17. A computer program product according to claim 16, the computer program product including a codec, the codec being adapted to co-operate with media player applications software implemented by the end station.

18. A computer program product comprising computer executable code for causing an end station to display content to a user, the content being formed from a sequence of data frames, each data frame being encoded using a predetermined algorithm, the sequence of data frames including at least one criteria frame indicating one or more criteria to be satisfied in order to allow at least some of the content to be displayed.

19. An end station for displaying content to a user, the content being formed from a sequence of data frames, each data frame being encoded using a predetermined algorithm, the sequence of data frames including at least one criteria frame indicating one or more criteria to be satisfied in order to allow at least some of the content to be displayed, the end station comprising:
A display;
A processor, the processor being adapted to:
Receive the content;
Determine if the next data frame is a criteria frame; and,
In response to a successful determination;
Determine the one or more criteria;
Compare the one or more criteria to user data, the user data indicating whether the criteria are satisfied for the respective user;
Decode a number of the following data frames in response to a successful comparison; and,
Display the content contained therein.

20. An end station according to claim 19, the end station further including a communications port for coupling to a communications system.

21. A method of controlling the display of content to a user at an end station, the content being formed from a sequence of data frames, each data frame being encoded using a predetermined algorithm, the sequence of data frames including at least one criteria frame indicating one or more criteria to be satisfied in order to allow at least some of the content to be displayed, the method comprising:
Receiving an indication of the criteria from the end station;
Comparing the indicated criteria to the user data to determine if the criteria are satisfied;
Generating a notification in response to a successful comparison;
Transferring the notification to the end station, the end station responding to the notification to:
Decode a number of the following data frames; and,
Display the content contained therein.

22. A method according to claim 21, the end station being adapted to generate an identifier that uniquely identifies the end station and transfer the identifier to the base station together with the indication of the criteria, the method including using the identifier to select the user data corresponding to the respective user.

23. A method according to claim 21, the method further including:
Determining the number of following data frames to decode based on the user data; and,
Transferring the number to the end station together with the notification.

24. A method according to claim 21, the criteria including the payment of funds, the user data indicating the balance of funds available for the respective user and the method including generating the notification if sufficient funds are available.

25. A method according to claim 24, wherein if insufficient funds are available the method includes:
Generating an insufficient funds notification;
Transferring the insufficient funds notification to the end station, the end station being adapted to respond to the insufficient funds notification by:
Displaying a transaction screen to the user, allowing the user to enter transaction details; and,
Transferring the transaction details to a remote transaction system via the communications port, the remote transaction system being adapted to authorize the transaction and transfer an indication of the authorization to the base station;
Receiving the indication of the authorization;
Updating the user data;
Re-comparing the criteria to the transaction content; and,
Generating the notification in response to a successful comparison.

26. A method of controlling the display of content to a user at an end station, the content being formed from a sequence of data frames, each data frame being encoded using a predetermined algorithm, the sequence of data frames including at least one criteria frame indicating one or more criteria to be satisfied in order to allow at least some of the content to be displayed.

27. A computer program product comprising computer executable code for causing a base station to control the display of content to a user at an end station, the content being formed from a sequence of data frames, each data frame being encoded using a predetermined algorithm, the sequence of data frames including at least one criteria frame indicating one or more criteria to be satisfied in order to allow at least some of the content to be displayed, the computer executable code being adapted to cause the base station to:
Receiving an indication of the criteria from the end station;
Comparing the indicated criteria to the user data to determine if the criteria are satisfied;
Generating a notification in response to a successful comparison;
Transferring the notification to the end station, the end station responding to the notification to:
Decode a number of the following data frames; and,
Display the content contained therein.

28. A computer program product comprising computer executable code for causing a base station to control the display of content to a user at an end station, the content being formed from a sequence of data frames, each data frame being encoded using a predetermined algorithm, the sequence of data frames including at least one criteria frame indicating one or more criteria to be satisfied in order to allow at least some of the content to be displayed.

29. A base station for controlling the display of content to a user at an end station, the content being formed from a sequence of data frames, each data frame being encoded using a predetermined algorithm, the sequence of data frames including at least one criteria frame indicating one or more criteria to be satisfied in order to allow at least some of the content to be displayed, the base station comprising:
A store for storing user data;
A processor, the processor being adapted to:
Receive an indication of the criteria from the end station;
Compare the indicated criteria to the user data to determine if the criteria are satisfied;
Generate a notification in response to a successful comparison;
Transfer the notification to the end station, the end station responding to the notification to:
Decode a number of the following data frames; and,
Display the content contained therein.

30. A base station according to claim 29, the base station further comprising communications port for coupling to a communications system and, the base station being adapted to communicate with the end station via the communications port.

31. A base station for controlling the display of content to a user at an end station, the content being formed from a sequence of data frames, each data frame being encoded using a predetermined algorithm, the sequence of data frames including at least one criteria frame indicating one or more criteria to be satisfied in order to allow at least some of the content to be displayed.

32. A system for displaying content to a user at an end station, the content being formed from a sequence of data frames, each data frame being encoded using a predetermined algorithm, the sequence of data frames including at least one criteria frame indicating one or more criteria to be satisfied in order to allow at least some of the content to be displayed.

33. A method of generating content to be displayed to a user at an end station, the content being formed from a sequence of data frames, each data frame being encoded using a predetermined algorithm, the sequence of data frames including at least one criteria frame indicating one or more criteria to be satisfied in order to allow at least some of the content to be displayed, the method comprising:
Selecting the content to be displayed;
Encoding the content as a number of data frames using a predetermined encoding algorithm;
Specifying the one or more criteria to be included in the criteria frames;
Generating the one or more criteria frames in accordance with the specified criteria, the criteria frames being encoded using the predetermined algorithm; and,
Generating the sequence of data frames in accordance with the content, the sequence of data frames including the one or more criteria frames.

34. A method according to claim 33, the criteria including details of one or more of:
The number of criteria frames to be included;
The relative separation of the criteria frames in the sequence of data frames;
Payment content, including an indication of the payment required to display a predetermined amount of content; and,
Information describing the author of the content.

35. A method of generating content to be displayed to a user at an end station, the content being formed from a sequence of data frames, each data frame being encoded using a predetermined algorithm, the sequence of data frames including at least one criteria frame indicating one or more criteria to be satisfied in order to allow at least some of the content to be displayed.

36. A computer program product comprising computer executable code which when implemented by a suitable processing system causes the processing system to generate content to be displayed to a user at an end station, the content being formed from a sequence of data frames, each data frame being encoded using a predetermined algorithm, the sequence of data frames including at least one criteria frame indicating one or more criteria to be satisfied in order to allow at least some of the content to be displayed, the computer executable code causing the processing system to:
Allow a user to select the content to be displayed;
Encode the content as a number of data frames using a predetermined encoding algorithm;
Allow the user to specifying the one or more criteria to be included in the criteria frames;
Generate the one or more criteria frames in accordance with the specified criteria, the criteria frames being encoded using the predetermined algorithm; and,
Generate the sequence of data frames in accordance with the content, the sequence of data frames including the one or more criteria frames.

37. A computer program product comprising computer executable code which when implemented by a suitable processing system causes the processing system to generate content to be displayed to a user at an end station, the content being formed from a sequence of data frames, each data frame being encoded using a predetermined algorithm, the sequence of data frames including at least one criteria frame indicating one or more criteria to be satisfied in order to allow at least some of the content to be displayed.

38. A processing system adapted to generate content to be displayed to a user at an end station, the content being formed from a sequence of data frames, each data frame being encoded using a predetermined algorithm, the sequence of data frames including at least one criteria frame indicating one or more criteria to be satisfied in order to allow at least some of the content to be displayed, the processing system comprises:
An input for receiving commands from a user;
A processor adapted to:
Receive the content to be displayed;
Encode the content as a number of data frames using a predetermined encoding algorithm;
Receive input commands from the user specifying the one or more criteria to be included in the criteria frames;
Generate the one or more criteria frames in accordance with the specified criteria, the criteria frames being encoded using the predetermined algorithm; and,
Generate the sequence of data frames in accordance with the content, the sequence of data frames including the one or more criteria frames.

39. A processing system adapted to generate content to be displayed to a user at an end station, the content being formed from a sequence of data frames, each data frame being encoded using a predetermined algorithm, the sequence of data frames including at least one criteria frame indicating one or more criteria to be satisfied in order to allow at least some of the content to be displayed.
